(19) United States
(12) Patent Application Publication
(10) Pub. No.: US 2026/0301449 A1
(43) Pub. Date: Oct. 1, 2026

(54) INFORMATION PROCESSING APPARATUS, INPUT AND OUTPUT APPARATUS, INFORMATION PROCESSING METHOD, METHOD, RECORDING MEDIUM, MODEL, AND INFORMATION

(71) Applicants: Naoki MOTOHASHI, Ohta-ku, Tokyo (JP); Ricoh Company, Ltd., Ohta-ku, Tokyo (JP)

(72) Inventor: Naoki MOTOHASHI, Kanagawa (JP)

(73) Assignee: Ricoh Company, Ltd., Ohta-ku, Tokyo (JP)

(21) Appl. No.: 19/489,793

(22) PCT Filed: Jun. 18, 2024
(86) PCT No.: PCT/IB2024/055922

§ 371 Date: Dec. 3, 2025

(30) Foreign Application Priority Data
Jul. 25, 2023 (JP) 2023-120634

(51) Int. Cl. G06V 20/70; G06F 16/3329

(52) U.S. Cl. CPC G06V 20/70; G06F 16/33295

(57) ABSTRACT

An information processing apparatus includes a storage unit to store a model generated by executing a training process with training data including an image and a text; and a text information generation unit to generate text information based on the model and a target image, the target image being identified on a display screen displayed on a display.

### TECHNICAL FIELD

The present disclosure relates to an information processing apparatus, an input and output apparatus, an information processing method, a method, a recording medium, a model, and an information processing system.

### BACKGROUND ART

Patent Literature (PTL) 1 discloses a technique for extracting a matching object to be matched three-dimensional model data that is from point cloud data including depth information, and matching the three-dimensional model data and the matching object to identify an object matching portion in the three-dimensional model data by using machine learning. Further, PTL 1 discloses a technique for identifying a target position in a building based on information on the object matching portion in the three-dimensional model data and the depth information of the point cloud data.

### CITATION LIST

### Patent Literature

### PTL 1

Japanese Patent No. 7113611

### SUMMARY OF INVENTION

### Technical Problem

Generating text information for a display screen according to the intention of a user has been desired.

### Solution to Problem

According to an embodiment of the disclosure, an information processing apparatus includes a storage unit to store a model generated by executing a training process with training data including an image and a text; and a text information generation unit to generate text information based on the model and a target image, the target image being identified on a display screen displayed on a display.

According to an embodiment of the disclosure, an input and output apparatus includes an input reception unit to receive at least one of a voice, a character, and an operation for identifying a target image on a display screen displayed on a display, and an output unit to output text information generated by a text information generation unit based on the target image and a model that is generated by executing a training process with training data including an image and a text.

According to an embodiment of the disclosure, an information processing method performed by an information processing apparatus includes generating text information based on a model generated by executing a training process with training data and a target image. The training data includes an image and a text. The target image is identified on a display screen displayed on a display.

According to an embodiment of the disclosure, a recording medium storing computer-readable code for controlling a computer system to carry out a method is provided. The method includes generating text information based on a model generated by executing a training process with training data and a target image. The training data includes an image and a text. The target image is identified on a display screen displayed on a display.

According to an embodiment of the disclosure, an input and output method performed by an input and output apparatus, includes receiving at least one of a voice, a character, and an operation for identifying a target image on a display screen displayed on a display, and outputting text information generated based on the target image and a model that is generated by executing a training process with training data including an image and a text.

According to an embodiment of the disclosure, a recording medium storing computer-readable code for controlling a computer system to carry out a method performed by an input and output apparatus is provided. The method includes receiving at least one of a voice, a character, and an operation for identifying a target image on a display screen displayed on a display, and outputting text information generated by a text information generation unit based on the target image and a model that is generated by executing a training process with training data including an image and a text.

According to an embodiment of the disclosure, a model is generated by executing a training process with training data including an image and an implicit knowledge comment for the image. The model causes a computer to output the implicit knowledge comment based on the image. The implicit knowledge comment is used for generating text information based on a target image identified on a display screen displayed on a display.

According to an embodiment of the disclosure, an information processing system includes an input and output apparatus and an information processing apparatus communicably connected to the input and output apparatus. The input and output apparatus includes an input reception unit to receive at least one of a voice, a character, and an operation for identifying a target image on a display screen displayed on a display, and a transmission unit configured to transmit the target image to the information processing apparatus. The information processing apparatus includes a reception unit to receive the target image transmitted from the input and output apparatus, and a transmission unit to transmit, to the input and output apparatus, a model generated by executing a training process with training data including an image and a text and text information generated based on the target image. The input and output apparatus further includes a reception unit to receive the text information transmitted from the information processing apparatus, and an output unit configured to output the text information.

### Advantageous Effects of Invention

According to an embodiment of the present disclosure, text information for a display screen according to the intention of a user can be generated.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic diagram illustrating an overview of an information processing system according to an embodiment of the present disclosure.

FIG. 2 is a block diagram illustrating a hardware configuration of each of a terminal device and a server according to an embodiment of the present disclosure.

FIG. 3 is a block diagram illustrating a functional configuration of an information processing system according to an embodiment of the present disclosure.

FIGS. 4A and 4B are conceptual diagrams illustrating an example of a user information management table and an image management table, respectively, according to an embodiment of the present disclosure.

FIG. 5 is a sequence diagram illustrating an example of a text information generation process according to an embodiment of the present disclosure.

FIG. 6 is a sequence diagram illustrating an example of a model update process according to an embodiment of the present disclosure.

FIGS. 7A and 7C are flowcharts each illustrating a process according to an embodiment of the present disclosure.

FIGS. 8A and 8B are diagrams illustrating a model update process and a text information generation process, respectively, according to an embodiment of the present disclosure.

FIGS. 9A and 9B are diagrams illustrating a model update process and a text information generation process, respectively, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the fields of civil engineering and architecture, the implementation of building information modeling (BIM)/construction information modeling (CIM) has been promoted for coping with, for example, the demographic shift towards an older population and enhancing labor efficiency and productivity.

BIM is a solution that involves utilizing a database of buildings, in which attribute data such as cost, finishing details, and management information, is added to a three-dimensional (3D) digital model of a building. This model is created on a computer and utilized throughout every stage of the architectural process, including design, construction, and maintenance. The three-dimensional digital model is referred to as a 3D model in the following description.

CIM is a solution that has been proposed for the field of civil engineering (covering general infrastructure such as roads, electricity, gas, water supply, etc.,) following BIM that has been advancing in the field of architecture. CIM is being pursued, similar to BIM, to aim for efficiency and advancement in a series of construction production systems by sharing information through centralized 3D models among participants.

A matter of concern for promoting BIM/CIM implementation is how to utilize constructed BIM/CIM.

In particular, the 3D space restored by BIM/CIM can be used for other works such as maintenance and site investigation as well as for design and construction. In addition to using the 3D space as a design drawing, for example, the 3D space can be used to leave a record on the 3D space or to share information on the 3D space between the users.

Further, since work performed on a digital basis can be recorded as a log, if implicit knowledge can be extracted based on the work, the implicit knowledge can be effectively used for technical transfer from an expert to a young person. This is expected to lead to front loading of business, human resource development, etc.

Focusing on the transfer of implicit knowledge, the transfer of implicit knowledge between different works or users with different skills is desired by not only using a 3D space but also using a spherical image, a planar image, etc., as described above.

In view of the above, an object of an embodiment of the present disclosure is to achieve the transfer of implicit knowledge about an image between different works or between users with different skill levels.

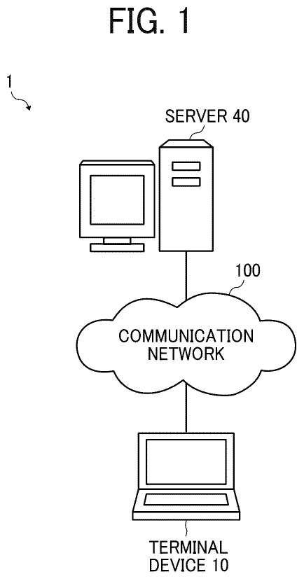

FIG. 1 is a schematic diagram illustrating an overview of an information processing system according to an embodiment of the disclosure. The information processing system 1 according to the present embodiment includes a terminal device 10 that is an example of an input and output apparatus, and a server 40.

The server 40 is an example of an information processing apparatus connected to an input and output apparatus via a network. The terminal device 10 may be a glass device or a wearable device. The number of terminal devices 10 included in the information processing system 1 may be plural.

The terminal device 10 and the server 40 can communicate with each other via a communication network 100. The communication network 100 is implemented by, for example, the Internet, a mobile communication network, or a local area network (LAN). The communication network 100 may include, in addition to wired communication networks, wireless communication networks in compliance with, for example, 3rd generation (3G), Worldwide Interoperability for Microwave Access (WiMAX), or long term evolution (LTE). Further, the terminal device 10 can establish communication using a short-range communication technology such as NEAR FIELD COMMUNICATION (NFC) (registered trademark).

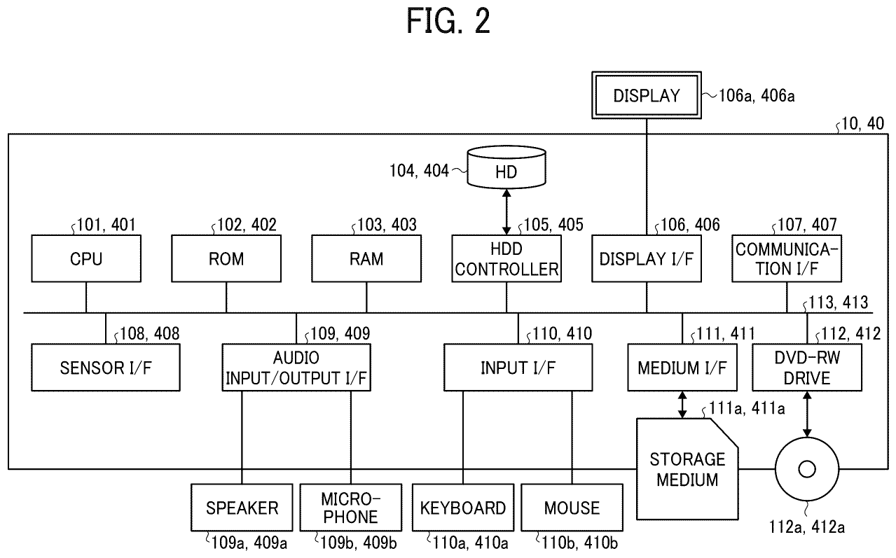

FIG. 2 is a block diagram illustrating a hardware configuration of each of a terminal device and a management apparatus according to the present embodiment. The hardware components of the terminal devices 10 are denoted by reference numerals in the 100 series.

The hardware components of the management apparatus are denoted by reference numerals in the 400 series.

Each hardware component of the terminal device 10 is described below. Since each hardware component of the server 40 is substantially the same as that of the terminal device 10, the redundant description is omitted.

The terminal device 10 is implemented by a computer as illustrated in FIG. 2 and includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 performs overall control of the operation of the terminal device 10. The ROM 102 stores a program used for driving the CPU 101, such as an initial program loader (IPL).

The RAM 103 is used as a working area for the CPU 101.

The HD 104 stores various data such as a program. The HDD controller 105 controls the reading or writing of various data from or to the HD 104 under the control of the CPU 101.

The display I/F 106 is a circuit to control a display 106a to display an image.

The display 106a is a type of display unit such as a liquid crystal display or an organic electro luminescence (EL) display that displays various types of information such as a cursor, a menu, a window, characters, or an image. The communication I/F 107 is an interface used for communication with another device (external device).

When the terminal device 10 is a glass device, the terminal device 10 may use a circuit that causes a lens as a transmissive reflective member to display an image in an alternative to the display I/F 106.

The communication I/F 107 is, for example, a network interface card (NIC) in compliance with transmission control protocol/internet protocol (TCP/IP).

The terminal device 10 further includes a sensor I/F 108, a sound input/output I/F 109, an input I/F 110, a medium I/F 111, and a digital versatile disk rewritable (DVD-RW) drive 112.

The sensor I/F 108 is an interface that receives information detected by various sensors. The sound input/output I/F 109 is a circuit that processes the input of sound signals from a microphone 109b and the output of sound signals to a speaker 109a under the control of the CPU 101. The input I/F 110 is an interface for connecting an input device to the terminal device 10.

A keyboard 110a is a type of input unit and includes multiple keys for inputting characters, numerals, or various instructions. A mouse 110b is a type of input device for selecting or executing various types of instructions, selecting a subject to be processed, moving a cursor, or performing an operation on a display screen.

The medium I/F 111 controls the reading or writing (storing) of data from or to a recording medium 111a such as a flash memory. The DVD-RW drive 112 controls the reading or writing of various data from or to a DVD-RW 112a that is an example of a removable recording medium. The removable recording medium is not limited to the DVD-RW and may be a DVD-recordable (DVD-R). Further, the DVD-RW drive 112 may be a BLU-RAY drive to control the reading or writing of various data from or to a BLU-RAY disc.

The terminal device 10 further includes a bus line 113. The bus line 113 includes an address bus and a data bus. The bus line 113 electrically connects the components, such as the CPU 101, with each other.

The above-mentioned programs may be stored in a recording medium, such as an HD and a compact disc read-only memory (CD-ROM), to be distributed domestically or internationally as a program product. For example, the terminal device 10 executes a program according to the present embodiment to implement an information processing method according to the present embodiment.

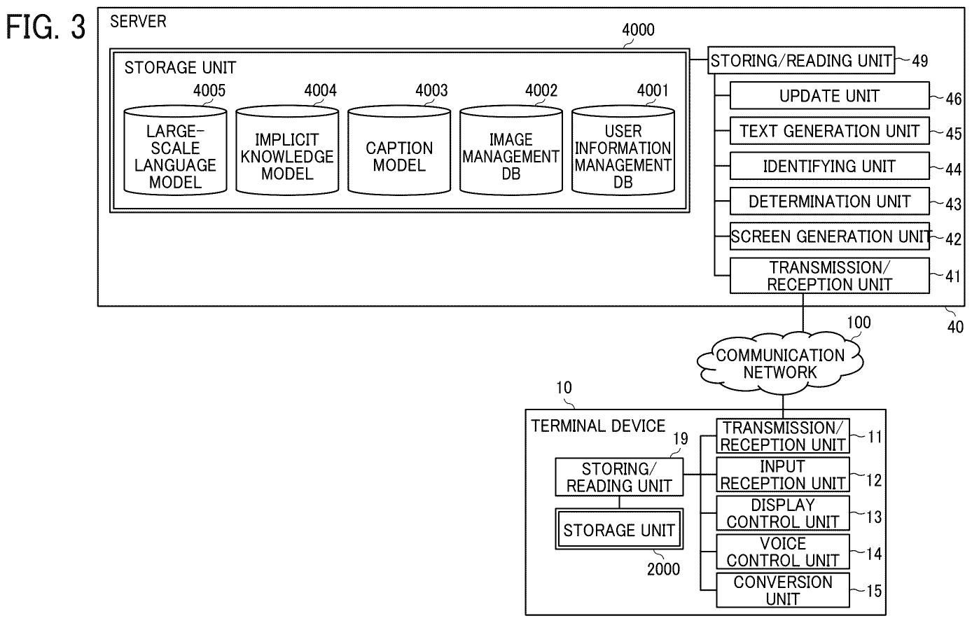

FIG. 3 is a block diagram illustrating a functional configuration of an information processing system according to the present embodiment.

As illustrated in FIG. 3, the terminal device 10 includes a transmission/reception unit 11, an input reception unit 12, a display control unit 13, a voice control unit 14, a conversion unit 15, and a storing/reading unit 19. Each of the above-mentioned units is a function that is implemented by or that is caused to function by operation of one or more of the components illustrated in FIG. 2, performed according to an instruction from the CPU 101 according to a program loaded from the HD 104 to the RAM 103. The terminal device 10 further includes a storage unit 2000 including the RAM 103 and the HD 104 illustrated in FIG. 2.

### Functional Units of Terminal Device

Functional units of the terminal device 10 are described below.

The transmission/reception unit 11 is an example of a transmission unit and is implemented by an instruction from the CPU 101 illustrated in FIB. 2 and the network I/F 107 illustrated in FIG. 2. The transmission/reception unit 11 transmits and receives various data (or information) to and from another terminal, device, apparatus, or system via the communication network 100.

The input reception unit 12 is an example of a reception unit and is implemented by an instruction from the CPU 101 illustrated in FIG. 2 in addition to the input I/F 110 and the audio input/output I/F 109, and receives various inputs from a user via the microphone 109b, the keyboard 110a or the mouse 110b illustrated in FIG. 2.

The display control unit 13 is an example of a display control unit or an output unit and is implemented by an instruction from the CPU 101 illustrated in FIG. 2 and the display I/F 106 illustrated in FIG. 2. The display control unit 13 causes the display 106a that is an example of a display unit to display various images and screens.

When the terminal device 10 is a glass device, the display control unit 13 causes a transmissive reflective member such as a lens to display an image in an alternative to the display I/F 106.

The voice control unit 14 is an example of a voice control unit or an output unit and is implemented by an instruction from the CPU 101 illustrated in FIG. 2 and the audio input/output I/F 109 illustrated in FIG. 2. The voice control unit 14 causes the speaker 109a that is an example of a sound reproducing unit to reproduce sound.

The conversion unit 15 is an example of a processing unit, is implemented by an instruction from the CPU 101 illustrated in FIG. 2, and performs processing for converting character information into voice information and processing for converting voice information into character information.

The storing/reading unit 19 is an example of a storage control unit and is implemented by an instruction from the CPU 101 illustrated in FIG. 2, the HD 104, the medium I/F 111, and the DVD-RW drive 112 illustrated in FIG. 2. The storing/reading unit 19 stores various data in the storage unit 2000, the recording medium 111a, or the DVD-RW 112a and reads various data from the storage unit 2000, the recording medium 111a, or the DVD-RW 112a.

### Functional Configuration of Server

The server 40 includes transmission/reception unit 41, a screen generation unit 42, a determination unit 43, an identifying unit 44, a text generation unit 45, an update unit 46, and a storing/reading unit 49. Each of the above-mentioned units is a function that is implemented by or that is caused to function by operation of one or more of the components illustrated in FIG. 2, performed according to an instruction from the CPU 401 according to a program expanded from the HD 404 to the RAM 403. The server 40 further includes a storage unit 4000 implemented by the HD 404 in FIG. 2. The storage unit 4000 is an example of a memory.

### Functional Units of Server

Functional units of the server 40 are described below. The server 40 may be implemented by multiple computers in a manner that some or all of the functions are distributed to the multiple computers. Although the server 40 is a server computer that resides in a cloud environment in the following description of the present embodiment, alternatively, the management server 5 may be a server that resides in an on-premises environment.

The transmission/reception unit 41 is an example of a transmission unit and is implemented by an instruction from the CPU 401 illustrated in FIB. 2 and the network I/F 407 illustrated in FIG. 2. The transmission/reception unit 41 transmits and receives various data (or information) to and from another terminal, device, apparatus, or system via the communication network 100.

The screen generation unit 42 is an example of a screen generation unit, is implemented by an instruction from the CPU 401 illustrated in FIG. 2, and generates various screens.

The determination unit 43 is an example of a determination unit, is implemented by an instruction from the CPU 401 illustrated in FIG. 2, and performs various determinations described later.

The identifying unit 44 is an example of an identifying unit, is implemented by an instruction from the CPU 401 illustrated in FIG. 2, and identifies a target image.

The text generation unit 45 is an example of a text information generation unit, is implemented by an instruction from the CPU 401 illustrated in FIG. 2, and generates text information.

The update unit 46 is an example of an update unit, is implemented by an instruction from the CPU 401 illustrated in FIG. 2, and performs various settings and determinations described later.

The storing/reading unit 49 is an example of a storage control unit and is implemented by an instruction from the CPU 401 illustrated in FIG. 2, the HD 404, the medium I/F 411, and the DVD-RW drive 412 illustrated in FIG. 2. The storing/reading unit 49 stores various data in the storage unit 4000, the recording medium 411a, or the DVD-RW 412a and reads various data from the storage unit 4000, the recording medium 411a, or the DVD-RW 412a. The storage unit 4000, the recording medium 411a, and the DVD-RW 412a are examples of storage unit.

The storage unit 4000 includes a user information management DB 4001 including a user information management table, an image management DB 4002 including an image information management table, a caption model 4003, an implicit knowledge model 4004, and a large-scale language model 4005.

The user information management DB 4001 stores and manages various types of information, and the image management DB 4002 stores and manages various types of images such as a three-dimensional image related to a three-dimensional point cloud or a three-dimensional model, and a captured omnidirectional image.

The caption model 4003 is a model that is generated by executing a training process using a combination of an image and a caption comment as training data and causes a computer to function to output a caption comment based on the image. For example, the training process involves storing an image and caption comment as parameters and updating the parameters each time a new image and caption comment are trained.

The caption comment is represented by text data, and is a comment for explaining an image among comments indicated by voice or characters.

The implicit knowledge model 4004 is a model that is generated by executing a training process using a combination of an image and an implicit knowledge comment for the image as training data and causes a computer to function to output the implicit knowledge comment based on the image. For example, the training process involves storing an image and implicit knowledge comment as parameters and updating the parameters each time a new image and implicit knowledge comment are trained.

The implicit knowledge comment is represented by text data, and is a comment other than a caption comment among comments indicated by voice or characters, that is, a comment relating to content that does not appear in the image.

The large-scale language model 4005 is a computer language model that is generated by executing a training process using a huge amount of unlabeled text as training data and includes an artificial neural network having a large number of parameters. For example, the training process involves storing an input text and output text as parameters and updating the parameters each time a new input text and output text are trained.

The large-scale language model 4005 can capture many of the syntax and meanings of human words by sufficiently training with a method for learning context, such as “next sentence prediction” for understanding context by determining whether Sentence 1 and Sentence 2 are continuous, or a “masked language model” for understanding context by masking a word in a sentence and predicting the masked word from the words before and after the masked word.

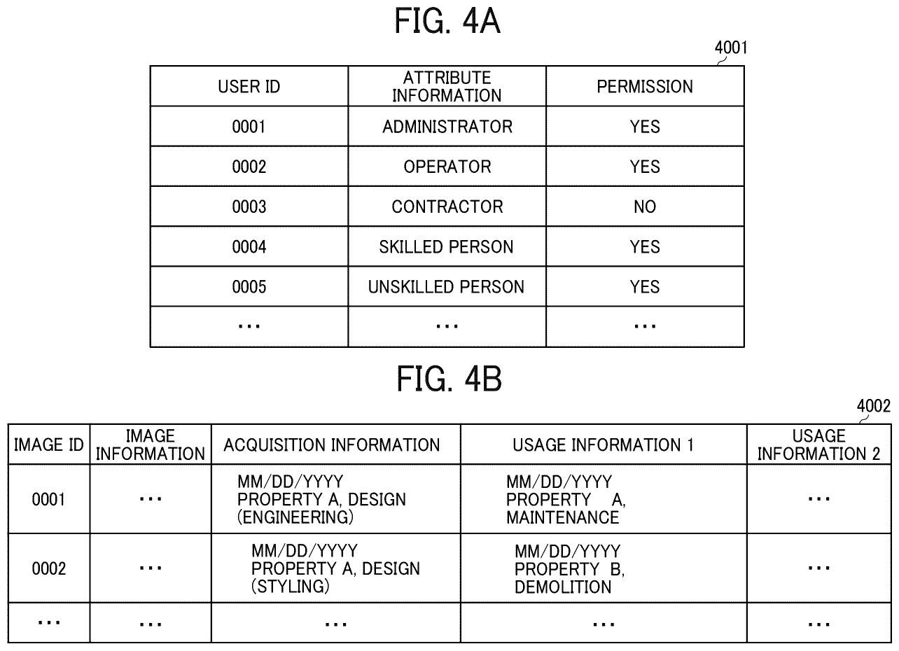

FIG. 4A is a conceptual diagram illustrating a user information management table according to the present embodiment.

The storage unit 4000 includes the user information management DB 4001 including the user information management table as illustrated in FIG. 4A. In the user information management table, attribute information indicating the attribute of a user and information on user permission indicating whether the user is permitted to use the text generation unit 45 are associated with each other and managed for each user ID. The attribute information indicates, for example, an administrator, an operator, a contractor, a skilled person, and an unskilled person.

FIG. 4B is a conceptual diagram illustrating an example of an image management table according to the present embodiment.

The storage unit 4000 stores the image management DB 4002 including the image management table as illustrated in FIG. 4B.

In the image management table, image information such as a three-dimensional image or a captured omnidirectional image, acquisition information for identifying an acquisition scenario in which the image information is acquired, and usage information for identifying a use scenario in which the image information or a display screen including the image information is used are associated with each other and managed for each image ID.

The acquisition information includes a date when the image information is acquired, a property name indicated by the image information, and a phase name indicating in which phase the image information is acquired. The usage information includes a date when the image information was used, a property name indicating for which the image information is used, and a phase name indicating for which phase the image information is used. Multiple pieces of usage information are managed in the image management table.

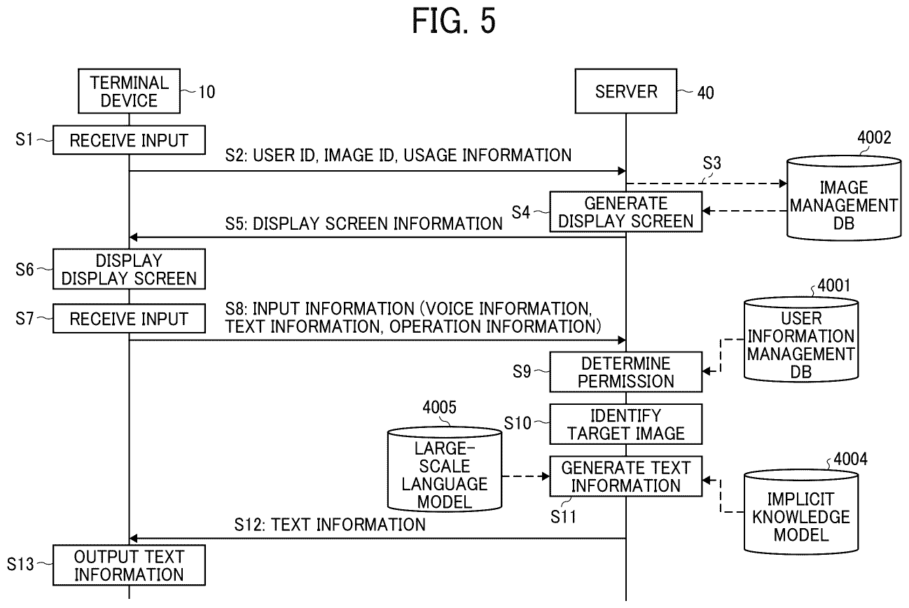

FIG. 5 is a sequence diagram illustrating an example of a text information generation process according to the present embodiment.

The input reception unit 12 of the terminal device 10 receives an input operation related to a user ID, an image ID, and usage information on an input/output screen displayed on the display 106a (Step S1). The transmission/reception unit 11 transmits the user ID, the image ID, and the usage information received in Step S1 to the server 40, and the transmission/reception unit 41 of the server 40 receives the user ID, the image ID, and the usage information transmitted from the terminal device 10 (Step S2).

Subsequently, the storing/reading unit 49 of the server 40 stores the usage information received in Step S2 in the image management DB 4002 in association with the image ID, and searches the image management DB 4002 using the image ID received in Step S2 as a search key to read image information, acquisition information, and usage information associated with the image ID (Step S3).

The screen generation unit 42 generates a display screen including the image information read by the storing/reading unit 49 (Step S4).

In Step S1, multiple image IDs may be input, and in Step S3, the image management DB 4002 is searched using the multiple image IDs as search keys, and multiple pieces of image information can be read.

In addition, in Step S1, a material ID for identifying a material including a desired image may be input in an alternative to the image ID, and the image management DB 4002 may manage one or more pieces of image information in association with the material ID.

Accordingly, in Step S2, the transmission/reception unit 11 transmits the material ID in an alternative to the image ID, and in Step S3, the image management DB 4002 is searched using the material ID as a search key to read one or more pieces of image information associated with the material ID.

The transmission/reception unit 41 transmits display screen information representing the display screen generated in Step S4 to the terminal device 10, and the transmission/reception unit 11 of the terminal device 10 receives the display screen information transmitted from the server 40 (Step S5). In some embodiments, instead of Steps S1 to S5, the transmission/reception unit 11 of the terminal device 10 may receive information indicating a captured image transmitted from the imaging device as the display screen information.

The display control unit 13 of the terminal device 10 displays the display screen received in Step S5 on the display 106a (Step S6). In some embodiments, the display control unit 13 may display an image managed by the terminal device 10 on the display 106a as a display screen instead of the display screen received in Step S5. The input reception unit 12 of the terminal device 10 receives input information input by the user on the display screen displayed on the display (Step S7).

The input information may include voice information, character information, or operation information input by the user, and the conversion unit 15 may convert the voice information included in the input information into the character information. The voice information, the character information, and the operation information include identification information for identifying a target image on the display screen and a question about the target image.

The transmission/reception unit 11 transmits the input information received by the input reception unit 12 to the server 40, and the transmission/reception unit 41 of the server 40 receives the input information transmitted from the terminal device 10 (Step S8). In some embodiments, the transmission/reception unit 11 may transmit display screen information in which a captured image or an image managed by the terminal device 10 is set to a display screen to the server 40 along with the input information, and the transmission/reception unit 41 of the server 40 may receive the input information and the display screen information transmitted from the terminal device 10.

The storing/reading unit 49 searches the user information management DB 4001 using the user ID received in Step S2 as a search key to read the user attribute and the information on the user permission that are associated with the user ID, and the determination unit 43 determines whether the user is permitted to us the text generation unit 45 based on the information on the user permission read from the user information management DB 4001 (Step S9).

When the determination in Step 9 indicates that the user is with the permission, the identifying unit 44 identifies a target image on the display screen based on the identification information included in the input information received in Step S8 (Step S10).

The text generation unit 45 acquires an implicit knowledge comment based on the implicit knowledge model 4004 using the target image identified in Step S10, and generates text information based on the large-scale language model 4005 using the implicit knowledge comment and a question extracted from the input information received in Step S8 (Step S11).

The text generation unit 45 may convert voice information included in the input information into character information, and the text information generated by the text generation unit 45 may be either voice information or character information.

The text generation unit 45 may generate text information without using a question, or may generate a fixed question in the system and use the fixed question. In this case, the question sentence is not visible to the user. Alternatively, the text generation unit 45 may generate a fixed question in the system, cause a display unit to display the fixed question, cause the user to select the fixed question, and use the selected question.

The transmission/reception unit 41 transmits the text information generated in Step S11 to the terminal device 10, and the transmission/reception unit 11 of the terminal device 10 receives the text information transmitted from the server 40 (Step S12).

When the received text information is character information, the display control unit 13 of the terminal device 10 displays the text information on the display 106a, or the conversion unit 15 converts the received text information into voice information and the voice control unit 14 reproduces the converted text information by the speaker 109a (Step S13). When the received text information is voice information, the text information is reproduced by the speaker 109a, or the conversion unit 15 converts the received text information into character information and displays the converted text information on the display 106a.

In the above description, when the information processing system 1 includes multiple terminal devices 10, each set of Steps S1 and S2, Steps S5 and S6, Steps S7 and S8, and Steps S12 and S13 may be executed by different one of terminal devices or may be executed by two or more of the multiple terminals.

The functional units of the server 40 in FIG. 3 may be integrated into the terminal device 10, and the terminal device 10 may execute the processing of the server 40 in FIG. 5.

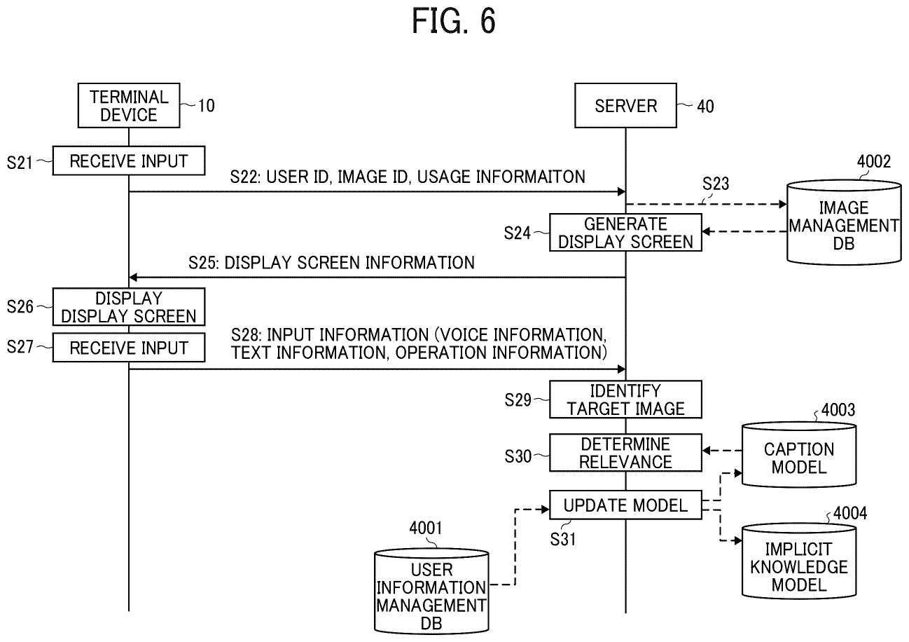

FIG. 6 is a sequence diagram illustrating an example of a model update process according to the present embodiment.

The input reception unit 12 of the terminal device 10 receives an input operation related to a user ID, an image ID, and usage information on an input/output screen displayed on the display 106a (Step S21). The transmission/reception unit 11 transmits the user ID, the image ID, and the usage information received in Step S21 to the server 40, and the transmission /reception unit 41 of the server 40 receives the user ID, the image ID, and the usage information transmitted from the terminal device 10 (Step S22).

Subsequently, the storing/reading unit 49 of the server 40 stores the usage information received in Step S22 in the image management DB 4002 in association with the image ID, and searches the image management DB 4002 using the image ID received in Step S22 as a search key to read image information, acquisition information, and usage information associated with the image ID (Step S23).

The screen generation unit 42 generates a display screen including the image information read by the storing/reading unit 49 (Step S24).

In Step S21, multiple image IDs may be input, and in Step S23, the image management DB 4002 is searched using the multiple image IDs as search keys, and multiple pieces of image information can be read.

In addition, in Step S21, a material ID for identifying a material including a desired image may be input in an alternative to the image ID, and the image management DB 4002 may manage one or more pieces of image information in association with the material ID.

Accordingly, in Step S22, the transmission/reception unit 11 transmits the material ID in an alternative to the image ID, and in Step S23, the image management DB 4002 is searched using the material ID as a search key to read one or more pieces of image information associated with the material ID.

The transmission/reception unit 41 transmits display screen information representing the display screen generated in Step S24 to the terminal device 10, and the transmission/reception unit 11 of the terminal device 10 receives the display screen information transmitted from the server 40 (Step S25). In some embodiments, instead of Steps S21 to S25, the transmission/reception unit 11 of the terminal device 10 may receive information indicating a captured image transmitted from the imaging device as the display screen information.

The display control unit 13 of the terminal device 10 displays the display screen received in Step S25 on the display 106a (Step S26). In some embodiments, the display control unit 13 may display an image managed by the terminal device 10 on the display 106a as a display screen instead of the display screen received in Step S25. The input reception unit 12 of the terminal device 10 receives input information input by the user on the display screen displayed on the display (Step S27).

The input information includes voice information, character information, or operation information input by the user, and the conversion unit 15 converts the voice information included in the input information into the character information. The voice information, the character information, and the operation information include identification information for identifying a target image on the display screen. The voice information and the character information include a caption comment describing the target image and an implicit knowledge comment relating to content that does not appear in the target image.

The transmission/reception unit 11 transmits the input information received by the input reception unit 12 and according to an input operation to the server 40, and the transmission/reception unit 41 of the server 40 receives the input information transmitted from the terminal device 10 (Step S28). In some embodiments, the transmission/reception unit 11 may transmit display screen information in which a captured image or an image managed by the terminal device 10 is set to a display screen to the server 40 along with the input information, and the transmission/reception unit 41 of the server 40 may receive the input information and the display screen information transmitted from the terminal device 10.

The identifying unit 44 identifies a target image on the display screen based on the identification information included in the input information received in Step S28 (Step S29).

The determination unit 43 acquires a caption comment based on the caption model 4003 using the target image identified in Step S29, and determines a relevance level between the caption comment and the comment included in the input information received in Step S28 (Step S30).

The determination unit 43 may determine a relevance level between the entire comment included in the input information received in Step S28 and the acquired caption comment, or may divide the comment included in the input information received in Step S28 into multiple comments and determine a relevance level between each of the divided comments and the acquired caption comment.

The update unit 46 updates the caption model 4003 with training data including the comment determined to have a high relevance level in Step S30 as a caption comment and the target image identified in Step S29, and updates the implicit knowledge model 4004 with training data including the comment determined to have a low relevance level in Step S30 as an implicit knowledge comment and the target image identified in Step S29 (Step S31).

In Step S31, the storing/reading unit 49 searches the user information management DB 4001 using the user ID received in Step S22 as a search key to read the user attribute associated with the user ID, and the update unit 46 updates the implicit knowledge model 4004 with training data in which the acquisition information and the usage information that are related to the target image and read in Step S23 and the user attribute are included in the implicit knowledge comment.

In the above description, when the information process system 1 includes multiple terminal devices 10, each set of Steps S21 and S22, Steps S25 and S26, and Steps S27 and S28 may be executed by different one of terminal devices or may be executed by two or more of the multiple terminal devices. Further one of the multiple terminal device 10 may be used for the process in FIG. 5, and another one of the multiple terminal devices 10 may be used for the process in FIG. 6.

The functional units of the server 40 in FIG. 3 may be integrated into the terminal device 10, and the terminal device 10 may execute the processing of the server 40 in FIG. 6.

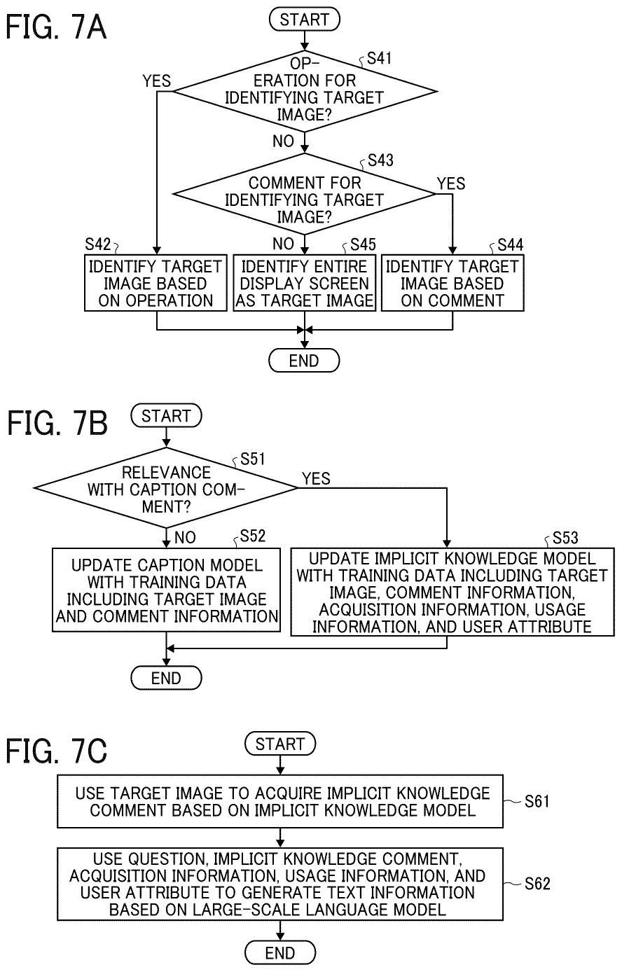

FIGS. 7A and 7C are flowcharts each illustrating a process according to the present embodiment.

FIG. 7A is a flowchart illustrating a process corresponding to Step S10 in FIG. 5 and Step S29 in FIG. 6.

The determination unit 43 determines whether the operation information included in the input information received from the terminal device 10 includes an operation for identifying a target image (Step S41). When the operation information includes the operation for identifying a target image, the identifying unit 44 identifies the target image according to the operation for identifying the target image (Step S42).

The determination unit 43 determines whether the voice information or the character information included in the input information received from the terminal device 10 includes a comment for identifying a target image (Step S43). When the comment for identifying the target image is included, the identifying unit 44 identifies the target image according to the comment for identifying the target image (Step S44). The comment for identifying a target image is, for example, a comment for identifying a position on the display screen such as right or left, or a comment for identifying the acquisition information for the image.

When the operation information does not include the operation for identifying a target image and the voice information and the character information do not include the comment for identifying a target image, the identifying unit 44 identifies the entire display screen as a target image (Step S45).

In Step S42, when the operation information includes operations each for identifying corresponding one of multiple target images, the identifying unit 44 may identify each of the multiple target images according to the corresponding operation.

In Step S44, when the voice information or the character information includes comments each for identifying corresponding one of multiple target images, the identifying unit 44 may identify each of the multiple target images according to the corresponding comment.

Further, when the operation information includes an operation for identifying a target image and the voice information or the character information includes a comment for identifying another target image, the identifying unit 44 may identify a target images according to the operation and the comment.

Further, in Step S45, when the text information is included in the display screen, the identifying unit 44 may identify a portion obtained by excluding the text information from the display screen as a target image.

FIG. 7B is a flowchart illustrating a process corresponding to Steps S30 and S31 in FIG. 6.

The determination unit 43 determines the relevance level between the caption comment acquired from the caption model 4003 using the target image and the comment included in the input information received from the terminal device 10 (Step S51). For example, when the ratio of the comment included in the input information that matches the caption comment is equal to or greater than a predetermined value, the determination unit 43 determines that the relevance level between the comment in the input information with the caption comment is high. When the comment has a high relevance level with the caption comment, this means that the comment is highly likely to explain the content of the target image.

The determination unit 43 may determine the relevance level between the entire comment included in the input information received from the terminal device 10 and the acquired caption comment, or may divide the comment included in the input information received from the terminal device 10 into multiple comments and determine a relevance level between each of the divided comments and the acquired caption comment.

For example, after determining an object in the target image by image recognition or object detection, the determination unit 43 may determine whether a word related to a caption comment representing the object is included in the comment included in the input information, or may determine the ratio of the included words (the number of words) as the relevance level.

The update unit 46 updates the implicit knowledge model 4004 with training data including the comment determined to have a low relevance level in Step S51 as an implicit knowledge comment, the target image, the acquisition information and the usage information that are related to the target image, and the user attribute (Step S52).

The update unit 46 updates the caption model 4003 with training data including the comment determined to have a high relevance level in Step S51 as a caption comment and the target image (Step S53).

The update of the implicit knowledge model 4004 and the caption model 4003 may be optional. In other words, when a predetermined condition is satisfied, the update unit 46 may update the implicit knowledge model 4004 by executing Step S52 or may update the caption model 4003 by executing Step S53.

FIG. 7C is a flowchart illustrating a process corresponding to Step S11 in FIG. 5.

The text generating unit 45 acquires the implicit knowledge comment based on the implicit knowledge model 4004 using the target image (Step S61), and generates text information based on the large-scale language model 4005 using the implicit knowledge comment, the question extracted from the input information received in Step S8, the acquisition information and the usage information read in Step S3 related to the target image, and the user attribute read in Step S9 (Step S62).

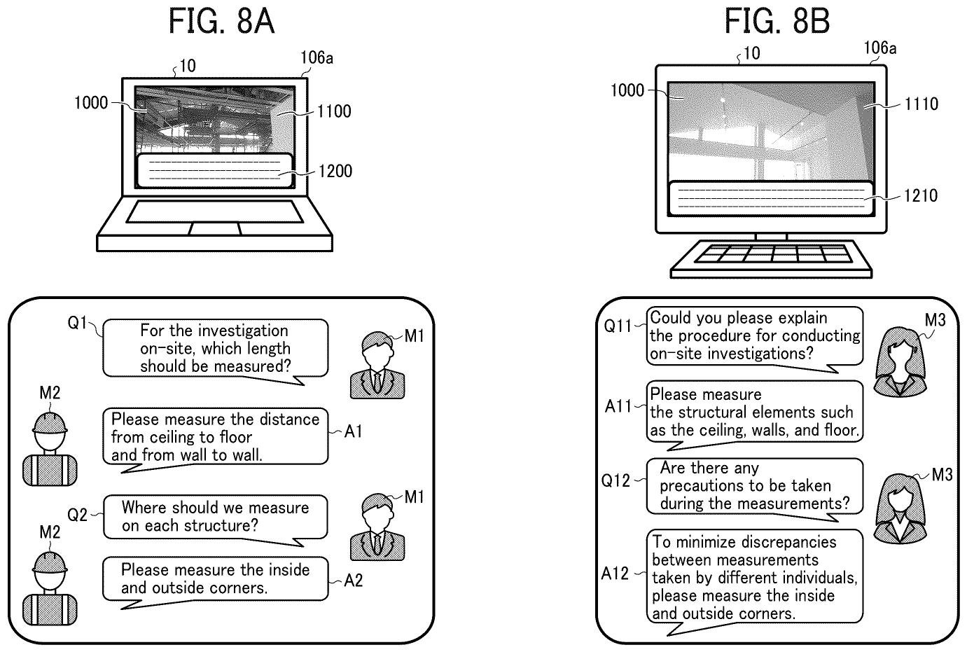

FIGS. 8A and 8B are diagrams illustrating a model update process and a text information generation process, respectively, according to the present embodiment.

FIG. 8A is a diagram illustrating the model update process corresponding to Steps S26 and S27 in FIG. 6 and FIGS. 7A and 7B.

The display control unit 13 of the terminal device 10 displays the display screen 1000 received from the server 40 on the display 106a, and the display screen 1000 includes an image 1100 and a text 1200.

The input reception unit 12 of the terminal device 10 receives voice information indicating a conversation including utterances Q1, A1, Q2, and A2 between a user M1 and a user M2, as input information input by the user on the display screen 1000, via the microphone 109b.

The identifying unit 44 identifies the image 1100, which is a portion obtained by removing the text 1200 from the display screen 1000, as a target image.

Then, the determination unit 43 determines the relevance level between the caption comment acquired from the caption model 4003 using the image 1100 that is the target image and the conversation including the utterances Q1, A1, Q2, and A2.

The update unit 46 updates the implicit knowledge model 4004 with training data including the comment determined to have a low relevance level among the utterances of the conversations Q1, A1, Q2, and A2 as the implicit knowledge comment and the image 1100 that is the target image, and updates the caption model 4003 with training data including the comment determined to have a high relevance level as the caption comment and the image 1100 that is the target image.

FIG. 8B is a diagram illustrating the text information generation process corresponding to Steps S6, S7, and S13 in FIG. 5 and FIGS. 7A and 7B.

The display control unit 13 of the terminal device 10 displays the display screen 1000 received from the server 40 on the display 106a, and the display screen 1000 includes an image 1110 and a text 1210.

The input reception unit 12 of the terminal device 10 receives voice information indicating questions Q11 and Q12 uttered by a user M3, as input information input by the user on the display screen 1000, via the microphone 109b.

The identifying unit 44 identifies the image 1110, which is a portion obtained by removing the text 1210 from the display screen 1000, as a target image.

The text generation unit 45 acquires an implicit knowledge comment based on the implicit knowledge model 4004 using the target image 1110, and generates text information related to answers A11 and A12 to the questions Q11 and Q12, respectively, based on the large-scale language model 4005 using the implicit knowledge comment, the questions Q11 and Q12, etc.

The display control unit 13 of the terminal device 10 displays the text information related to the A11 and A12 received from the server 40 on the display 106a.

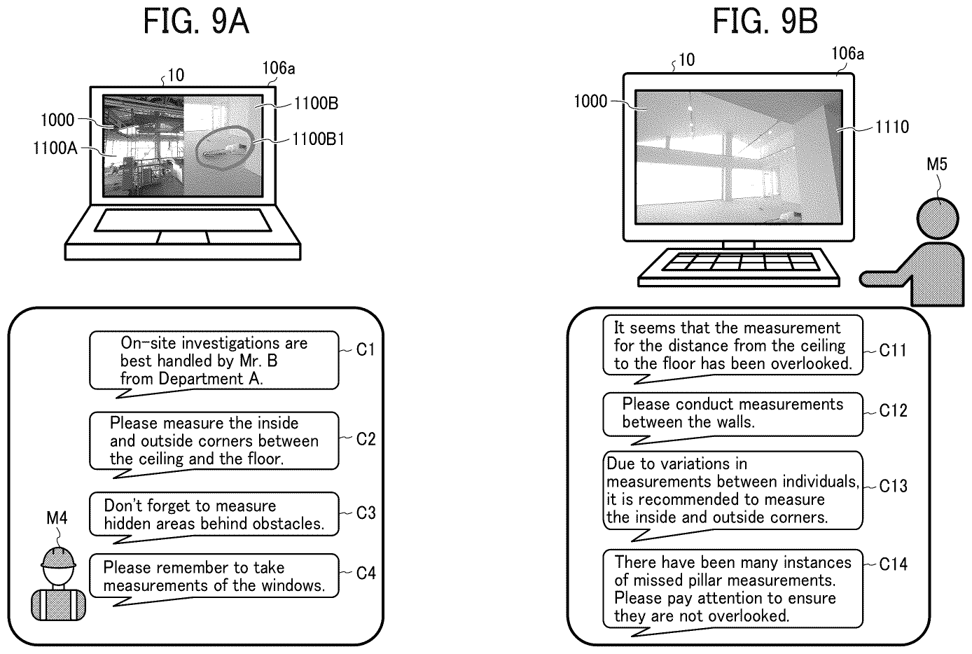

FIGS. 9A and 9B are diagrams illustrating a model update process and a text information generation process, respectively, according to the present embodiment.

FIG. 9A is a diagram illustrating the model update process corresponding to Steps S26 and S27 in FIG. 6 and FIGS. 7A and 7B.

The display control unit 13 of the terminal device 10 displays the display screen 1000 received from the server 40 on the display 106a, and the display screen 1000 includes a first image 1100A and a second image 1100B.

The input reception unit 12 of the terminal device 10 receives character information indicating comments C1 to C4 of a user M4, as input information input by the user on the display screen 1000, via the keyboard 110a.

The input reception unit 12 receives operation information indicating an operation for identifying a partial image 1100B1 in the second image 1100B performed by the user M4, as input information input by the user on the display screen 1000 via the mouse 110b.

The identifying unit 44 identifies the second image 1100B on the display screen 1000 as a target image according to the operation information. The identifying unit 44 may identify the partial image 1100B1 as a target image.

Then, the determination unit 43 determines the relevance level between the caption comment acquired from the caption model 4003 using the second image 1100B that is the target image and the comments C1 to C4.

The update unit 46 updates the implicit knowledge model 4004 with training data including the comment determined to have a low relevance level among the comments C1 to C4 as the implicit knowledge comment and the second image 1100B that is the target image, and updates the caption model 4003 with training data including the comment determined to have a high relevance level as the caption comment and the second image 1100B that is the target image.

FIG. 9B is a diagram illustrating the text information generation process corresponding to Steps S6, S7, and S13 in FIG. 5 and FIGS. 7A and 7B.

The display control unit 13 of the terminal device 10 displays the display screen 1000 received from the server 40 on the display 106a, and the display screen 1000 includes the image 1110.

An input on the displayed display screen 1000 is not performed by a user M5, and the input reception unit 12 does not receive input information input by the user on the display screen 1000. The identifying unit 44 identifies the image 1110, which is the entire display screen 1000, as a target image.

When the user M5 performs an operation for identifying a partial image such as the partial image 1100B1 in FIG. 9A on the display screen 1000B, the input reception unit 12 receives operation information indicating the operation for identifying the partial image as input information via the mouse 110b. In this case, the identifying unit 44 identifies the partial image on the display screen 1000 as a target image according to the operation information.

The text generation unit 45 acquires an implicit knowledge comment based on the implicit knowledge model 4004 using the target image 1110, and generates text information related to the comments C11 to C14 based on the large-scale language model 4005 using, for example, the implicit knowledge comment. The text generation unit 45 may generate text information using a preset template question.

The display control unit 13 of the terminal device 10 displays the text information related to the comments C11 to C14 received from the server 40 on the display 106a.

### Aspect 1

As described above, the server 40 according to an embodiment of the present disclosure includes the storage unit 4000 for storing the implicit knowledge model 4004 generated by executing a training process with training data including an image and a text, and the text generation unit 45 for generating text information based on the implicit knowledge model 4004 and a target image identified by the identifying unit 44 on the display screen 1000 displayed on the display 106a.

The server 40 is an example of an information processing apparatus, and the text generation unit 45 is an example of a text information generation unit.

With the above-described configuration, the server 40 can generate the text information related to implicit knowledge according to the intention of a user based on the target image identified on the display screen 1000.

### Aspect 2

In Aspect 1, the text generation unit 45 generates the text information based on user information for identifying a user.

Accordingly, the server 40 can change whether to generate the text information based on information on user permission corresponding to the user information, change the content of the text information based on a user attribute corresponding to the user information, or change the content of the implicit knowledge model 4004 for generating the text information.

### Aspect 3

In Aspect 1 or Aspect 2, the display screen 1000 is associated with at least one of acquisition information for identifying an acquisition scenario in which an image used for generating the display screen 1000 is acquired and usage information for identifying a use scenario in which the display screen 1000 is used.

Accordingly, the server 40 can generate the text information according to the intention of a user based on the target image on the display screen 1000 based on the image acquired in each of various acquisition scenarios or the target image on the display screen 1000 used in each of various use scenarios.

### Aspect 4

In any one of Aspect 1 to Aspect 3, the text generation unit 45 generates the text information based on at least one of acquisition information for identifying an acquisition scenario in which a source image that is a source of the display screen 1000 is acquired and usage information for identifying a use scenario in which the display screen 1000 is used.

Accordingly, the server 40 can generate the text information suitable for the intention of a user according to the acquisition scenario or the use scenario.

### Aspect 5

In any one of Aspect 1 to Aspect 4, the text generation unit 45 generates the text information based on the implicit knowledge model 4004, the target image, voice information, and character information. Each of the voice information and the character information is an example of input information received by the input reception unit 12 when the display screen 1000 is displayed on the display 106a.

Accordingly, the server 40 can generate the text information suitable for the intention of a user according to the voice information or the character information that has been input.

### Aspect 6

In Aspect 5, when the voice information or the character information that is an example of the input information includes a question, the text information includes an answer to the question. Accordingly, the server 40 can generate the text information suitable for the intention of a user according to the input question.

### Aspect 7

In any one of Aspect 1 to Aspect 6, the information processing apparatus further includes the update unit 46 that is an example of a model update unit for updating the implicit knowledge model 4004 with training data including the target image identified on the display screen 1000 displayed on the display 106a and the text information based on at least one of voice information and character information received by the input reception unit 12.

Accordingly, the server 40 updates the implicit knowledge model 4004 with the training data including the target image and the text data, and can generate accurate text information.

### Aspect 8

In Aspect 7, the update unit 46 updates the implicit knowledge model 4004 based on at least one of user information for identifying a user, acquisition information for identifying an acquisition scenario in which an image being a source of the display screen 1000 is acquired, and usage information for identifying a use scenario in which the display screen 1000 is used.

Accordingly, the server 40 can generate accurate text information by including the user attribute based on the user information, the acquisition information, and the usage information in the training data.

### Aspect 9

In Aspect 8, the update unit 46 updates the implicit knowledge model 4004 based on a relevance level between the target image and the text data.

Accordingly, the server 40 can generate accurate text information by updating the implicit knowledge model 4004 based on the target image and the relevance level with the text data.

### Aspect 10

In Aspect 9, the update unit 46 updates the implicit knowledge model 4004 based on the relevance level between a caption comment indicating the content of the target image and the text data.

Accordingly, the server 40 can generate accurate text information by updating the implicit knowledge model 4004 based on the caption comment indicating the content of the target image and the relevant level with the text data.

### Aspect 11

The terminal device 10 that is an example of an input and output apparatus according to an embodiment of the present disclosure includes the input reception unit 12 for receiving a voice, a character, or an operation for identifying a target image on the display screen 1000 displayed on the display 106a. The terminal device 10 includes at least one of the display control unit 13 and the voice control unit 14 that are examples of an output unit for outputting text information generated by the text generation unit 45 based on the implicit knowledge model 4004 and the target image.

### Aspect 12

An information processing method according to an embodiment of the present disclosure is an information processing method performed by the server 40. The information processing method includes Step S11 for executing text information generation based on the implicit knowledge model 4004 generated by executing a training process with training data including a target image identified on the display screen 1000 displayed on the display 106a, an image, and a text.

### Aspect 13

A program according to an embodiment of the present disclosure causes a computer to execute Step S11 for generating text information based on the implicit knowledge model 4004 generated by executing a training process with training data including a target image identified on the display screen 1000 displayed on the display 106a, an image, and a text.

### Aspect 14

A method for performing input and output by the terminal device 10 according to an embodiment of the present disclosure includes Step S7 for receiving an input of a voice, a character, or an operation for identifying a target image on the display screen 1000 displayed on the display 106a, and Step S13 for outputting text information generated by the text generation unit 45 based on the target image and the implicit knowledge model 4004 generated by executing a training process with training data including an image and a text.

### Aspect 15

A program causes a computer to execute a method according to an embodiment of the present disclosure. The method includes Step S7 for receiving an input of a voice, a character, or an operation for identifying a target image on the display screen 1000 displayed on the display 106a, and Step S13 for outputting text information generated by the text generation unit 45 based on the target image and the implicit knowledge model 4004 generated by executing a training process with training data including an image and a text.

### Aspect 16

A model according to an embodiment of the present disclosure is the implicit knowledge model 4004 that is generated by executing a training process with training data including an image and a text. The model causes a computer to function to output the text based on the image, and output the text used for generating text information by the text generation unit 45 based on a target image identified on a display screen 1000 displayed on the display 106a.

### Aspect 17

The information processing system 1 according to an embodiment of the present disclosure includes the terminal device 10 and the server 40 that is communicably connected to the terminal device 10. The terminal device 10 includes the input reception unit 12 for receiving a voice, a character, or an operation that identifies a target image on the display screen 1000 displayed on the display 106a, and the transmission/reception unit 11 for transmitting the target image to the server 40. The server 40 includes the transmission/reception unit 41 for receiving the target image transmitted from the terminal device 10 and transmitting text information generated based on the implicit knowledge model 4004 generated by executing a training process with training data including an image and a text, and the target image to the terminal device 10. The terminal device 10 receives the text information by the transmission/reception unit 11 from the server 40, and further includes at least one of the display control unit 13 and the voice control unit 14 for outputting the text information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2023-120634, filed on Jul. 25, 2023, in the Japan Patent Office, the entire disclosure of which is hereby incorporated by reference herein.

### REFERENCE SIGNS LIST

1 information processing system
100 communication network
10 terminal device (an example of an input and output apparatus)
11 transmission/reception unit (examples of a transmission unit and a reception unit)
12 input reception unit (an example of an input reception unit)
13 display control unit (examples of a display control unit and an output unit)
14 voice control unit (examples of a voice control unit and an output unit)
15 processing unit
19 storing/reading unit (an example of storage control unit)
106a display (an example of a display unit)
1000 storage unit (an example of a storage unit)
40 server (an example of an information processing apparatus)
41 transmission/reception unit (examples of a transmission unit and a reception unit)
42 screen generation unit (an example of a screen generation unit)
43 processing unit (an example of a three-dimensional information generation unit)
43 determination unit (an example of a determination unit)
44 identifying unit (an example of an identifying unit)
45 text generation unit (an example of a text generation unit)
46 update unit (an example of an update unit)
49 storing/reading unit (an example of storage control unit)
4000 storage unit (an example of a storage unit)
4001 user information management DB (an example of a user information management unit)
4002 image management DB (an example of an image management unit)
4003 caption model
4004 implicit knowledge model
4005 large-scale language model
1000 display screen
1100, 1110 image
1100A first image
1100B second image
1100B1 partial image
1200, 1210 text

1. An information processing apparatus comprising:
memory configured to store a model generated by executing a training process with training data including an image and a text; and
processing circuitry configured to generate text information based on the model and a target image, the target image being identified on a display screen displayed on a display.

2. The information processing apparatus of claim 1, wherein
the processing circuitry is configured to generate the text information based on user information for identifying a user.

3. The information processing apparatus of claim 1, wherein
the display screen is associated with at least one of acquisition information or usage information, the acquisition information identifying an acquisition scenario in which an image used for generating the display screen is acquired, and the usage information identifying a use scenario in which the display screen is used.

4. The information processing apparatus of claim 1, wherein
the processing circuitry is configured to generate the text information based on at least one of acquisition information or usage information, the acquisition information identifying an acquisition scenario in which a source image that is a source of the display screen is acquired, and the usage information identifying a use scenario in which the display screen is used.

5. The information processing apparatus of claim 1, wherein
the processing circuitry is configured to generate the text information based on the model, the target image, and input information, the input information being received, on the display screen displayed on the display.

6. The information processing apparatus of claim 5, wherein
in a case that the input information includes a question, the text information includes an answer to the question.

7. The information processing apparatus of claim 1, wherein the processing circuitry is further configured to:
update the model by using additional training data, the additional training data including the target image identified on the display screen displayed on the display and text data that is based on at least one of voice information or character information that are received by an input reception unit.

8. The information processing apparatus of claim 7, wherein the processing circuitry is further configured to:
update the model based on at least one of acquisition information or usage information, the acquisition information identifying an acquisition scenario in which a source image that is a source of the display screen is acquired, and the usage information identifying a use scenario in which the display screen is used.

9. The information processing apparatus of claim 8, wherein the processing circuitry is further configured to:
update the model based on a relevance level between the target image and the text data.

10. The information processing apparatus of claim 9, wherein the processing circuitry is further configured to:
update the model based on a caption comment describing content of the target image and the relevance level with the text data.

11. (canceled)

12. (canceled)

13. A non-transitory recording medium storing computer-readable code for controlling a computer system to carry out a method, the method comprising:
generating text information based on a model generated by executing a training process with training data and a target image, the training data including an image and a text, the target image being identified on a display screen displayed on a display.

14. (canceled)

15. (canceled)

16. The information processing apparatus of claim 1.
wherein the text is an implicit knowledge comment for the image,
wherein the model is configured to output the implicit knowledge comment based on the image, and
wherein the processing circuitry is configured to use the implicit knowledge comment being used for generating the text information based on a the target image

17. An information processing system, comprising:
an input and output apparatus; and
an information processing apparatus communicably connected to the input and output apparatus,
the input and output apparatus including first processing circuitry configured to:
receive at least one of a voice, a character, or an operation for identifying a target image on a display screen displayed on a display; and
transmit the target image to the information processing apparatus,
the information processing apparatus including second processing circuitry configured to:
receive the target image transmitted from the input and output apparatus; and
transmit, to the input and output apparatus, a model generated by executing a training process with training data including an image and a text and text information generated based on the target image,
wherein the first processing circuitry is further configured to:
receive the text information transmitted from the information processing apparatus; and
output the text information.
